(19) United States
(12) Patent Application Publication
(10) Pub. No.: US 2007/0185986 A1
(43) Pub. Date: Aug. 9, 2007

(54) Method and system of measuring and recording user data in a communications network

(76) Inventors: John Griffin, New South Wales (AU); Mark Long, New South Wales (AU)

Correspondence Address: DREIER LLP, 499 PARK AVE, NEW YORK, NY, 10022, US

(21) Appl. No.: 10/544,118

(22) PCT Filed: Jan. 29, 2004
(86) PCT No.: PCT/AU04/00098

§ 371 Date: Apr. 18, 2007

(30) Foreign Application Priority Data
Jan. 31, 2003 (AU) 2003900398

(51) Int. Cl. G06F 15/173

(52) U.S. Cl. 709/224; 381/58

(57) ABSTRACT

A system (2) for measuring and recording user data in a communications network and associating the user data with demographic data of the user, the user being able to access a user computer processing means (6) having browser means (18). The system comprises data processing means (4) for receiving from the browser means a measurement record after the user accesses a part of the network having a portion of measurement code embedded therein. The data processing means determines from the received measurement record whether a survey identified by a survey identifier has been presented to the user. The system further comprises first electronic storage means (12) for receiving survey response data of the user and the measurement record of the user.

### FIELD OF THE INVENTION

This invention relates to a method and system of measuring and recording user data in a communications network. More particularly, it relates to tracking an online population in a particular market segment linking demographic information of each entity in the population with usage of resources online.

### BACKGROUND OF THE INVENTION

It is known to measure and analyse usage of resources on a network using data sources retrieved from actions performed by users of the resources. Such measurement and analysis provides information about resources that do not have available statistics, such as site centric measurements.

For example, in International Patent Application Publication No. WO 01/11506 to the same applicant, a first data source is measured using monitored resources, such as monitored servers. This data source may comprise a site centric measurement such as census data or audit data, proxy or server log files. The resources may be any one of a web page, duration of viewing a particular web site or web page, page impressions or a feature of a web page or web site interacted by one or more users. A further data source may measure and analyse monitored users participating in a particular panel. A random sample of monitored users is recruited to form the panel from whom their interactions are measured and recorded in terms of accessing monitored and unmonitored resources. This further data source may comprise user centric measurements including panel data, sample data and survey data. Each monitored user of the group, termed a panelist, will have every page impression, web site access or time spent on a site or page or any other particular characteristic measured and recorded by a measurement code. The two sources of data are then used to obtain information about one or more of the resources.

A particular problem with the above mentioned measurement and analysis process is that to form a panel comprising a large number of panelists is particularly expensive. A further problem is that each PC used by each panelist must be metered and every access or page impression conducted by every panelist must have measurement code downloaded together with a requested resource to the panelist's browser on their PC. Still a further problem is that there is no information about the particular individuals of the panel as the information is used collectively in the group of panelists.

### SUMMARY OF THE INVENTION

According to a first aspect of the invention there is provided a system for measuring and recording user data in a communications network and associating the user data with demographic data of the user, the user being able to access a user computer processing means having browser means, the system comprising:

data processing means for receiving from the browser means a measurement record after the user accesses a part of the network having a portion of measurement code embedded therein;

the data processing means determining from the received measurement record whether a survey identified by a survey identifier has been presented to the user;

whereupon if the survey identifier is not detected, the data processing means forwards survey initiation code together with compatible measurement code to the user in order to complete a survey including the demographic data of the user;

the system further comprising:

first electronic storage means for receiving survey data of the user and the measurement record of the user, each being linked to one another and identified through a user identification code;

whereupon an interested party has access to information based on the measurement record and survey data of the user for the purpose of ascertaining information about the user in a market segment.

Prior to the data processing means receiving the measurement record from the browser means, the browser means may execute the portion of measurement code embedded in the accessed part of the network and send a request to the data processing means. Thereafter the data processing means delivers the compatible measurement code to the browser means.

The system may include a second electronic storage means, preferably in the form of a survey collection means, for storing the survey data including demographic data of the user. Preferably the second electronic storage means is linked to the data processing means, in the form of a data collection node, for receiving the survey response of the user. The first electronic storage means, preferably in the form of a market clickstream database, may be linked to the second electronic storage means for receiving the survey data of the user and also may be linked to the data processing means for receiving the measurement record. The first electronic storage means may process and assemble said information for the interested party based on the survey data and measurement record of the user and forward the information to an online reporting database. The online reporting database is then preferably accessed by the interested party to access the information. The information may be retrieved by the interested party compiling a set of queries.

The measurement record may include the user identification code or a cookie including the user identification code. The cookie may include the survey identifier, and where the survey identifier is detected then the survey identified by the survey identifier may not be delivered to the user browser means.

Where survey initiation code is forwarded to the user browser means, this may be appended to the measurement code forwarded by the data processing means and the cookie applied to the browser means. Once a survey is completed by the user this may then be appended to or tagged with the user cookie and returned to the data processing means for storage in the second electronic storage means.

Thus, for example, when a user accesses a web page having measurement code embedded therein, the browser of the user executes this code which causes a request to be made to the data processing means or data collection node. A measurement record is sent to the data collection node which includes user data, such as browser type, address, URL page etc and the user identification code, which may be included in a cookie. The cookie or measurement record will also include an indication as to whether the user has been presented with one or more surveys, each identified by a survey code.

If no particular survey is detected or identified by the data collection node, then it transmits survey initiation code together with the same measurement code to the browser of the user and a cookie is applied. The survey appears in a pop-up form and is preferably completed by the user and the measurement code goes on to record further user data such as page impressions. The survey data is then returned to the data collection node for storage in the survey collector or second electronic storage means. The survey data is appended to the cookie or user identification code.

The survey data and user data is forwarded to the market clickstream warehouse for further processing, which in turn formats certain information such as market rankings, site statistics for the online reporting database, which is then accessed by the interested parties.

Preferably where a survey, identified by a survey code, has been completed by the user and this is detected in the measurement record, it may be retrieved from the second storage means. Thus, in this instance the measurement record will contain user data, initially identifying IP address, Operating System type, URL of page or site accessed, and then later page impressions and web interactions, amount of time spent at a URL, for storage and later processing by the first storage means or clickstream warehouse.

According to a second aspect of the invention there is provided a method of measuring and recording user data in a communications network and associating the user data with demographic data of the user, the user being able to access a user computer processing means having browser means, the method comprising the steps of:

the user accessing a part of the network having a portion of measurement code embedded therein;

forwarding a measurement record from the browser means to a data processing means;

determining from the received measurement record whether a survey identified by a survey identifier has been presented to the user;

whereupon if the survey identifier is not detected, survey initiation code is forwarded with compatible measurement code to the user in order to complete a survey including the demographic data of the user; and

forwarding the completed survey data and measurement record to a first electronic storage means, each linked by a common user identification code;

such that an interested party has access to information based on the measurement record and survey data of the user for the purpose of ascertaining information about the user in a market segment.

Preferably, where a survey identifier is detected, indicating that a survey has been presented to the user, that survey data is stored in the first electronic storage means available for retrieval or processing. Preferably the stored survey data is identified by the common user identification code to enable the survey and its data to be used in conjunction with the measurement record.

According to a third aspect of the invention there is provided a system for measuring and recording user data in a communications network and associating the user data with demographic data of the user, the user being able to access a user computer processing means having browser means, the system comprising:

data processing means for receiving from the browser means a measurement record after the user accesses a part of the network having a portion of measurement code embedded therein;

wherein the data processing means determines from the received measurement record if the survey identified by a survey code has been presented to the user and completed by the user;

wherein where the survey has been completed by the user and survey data stored in a first electronic storage means, the measurement record, containing a portion of the user data is forwarded to the first electronic storage means;

the measurement record and the survey data, including demographic data of the user, identified by a user identification code;

wherein an interested party has access to information based on the measurement record and survey data of the user for the purpose of ascertaining information about the user in a market segment.

Preferably compatible measurement code is sent from the data processing means to the browser means in order to measure and record user data of the user as the user accesses various portions of the network, which may be the Internet.

Thus websites and web pages accessed may be measured together with page impressions and time spent at the site or page may be recorded and used with demographic data contained in the user survey.

According to a fourth aspect of the invention there is provided a system for measuring and recording user data in a communications network and associating the user data with demographic data of the user, the user being able to access a user computer processing means having browser means, the system comprising:

data processing means for receiving from the browser means a measurement record after the user accesses a part of the network having a portion of measurement code embedded therein, the measurement record forming part of the user data;

wherein a user identification code is applied to the browser means to provide the user data in the network in a market segment;

first electronic storage means for storing survey data containing the demographic data of the user; said survey data linked to the user data by the user identification code;

wherein an interested party obtains information about the user based on demographic data of the user in combination with the user data across the market segment.

### BRIEF DESCRIPTION OF THE DRAWINGS

Preferred embodiments of the invention will hereinafter be described, by way of example only, with reference to the drawings wherein:

FIG. 1 is a schematic diagram of a system used to obtain demographic data of one or more users and user data in accordance with the invention; and

FIG. 2 is a flow chart depicting the initiation of a survey for the user to complete.

### DETAILED DESCRIPTION OF THE PREFERRED EMBODIMENTS

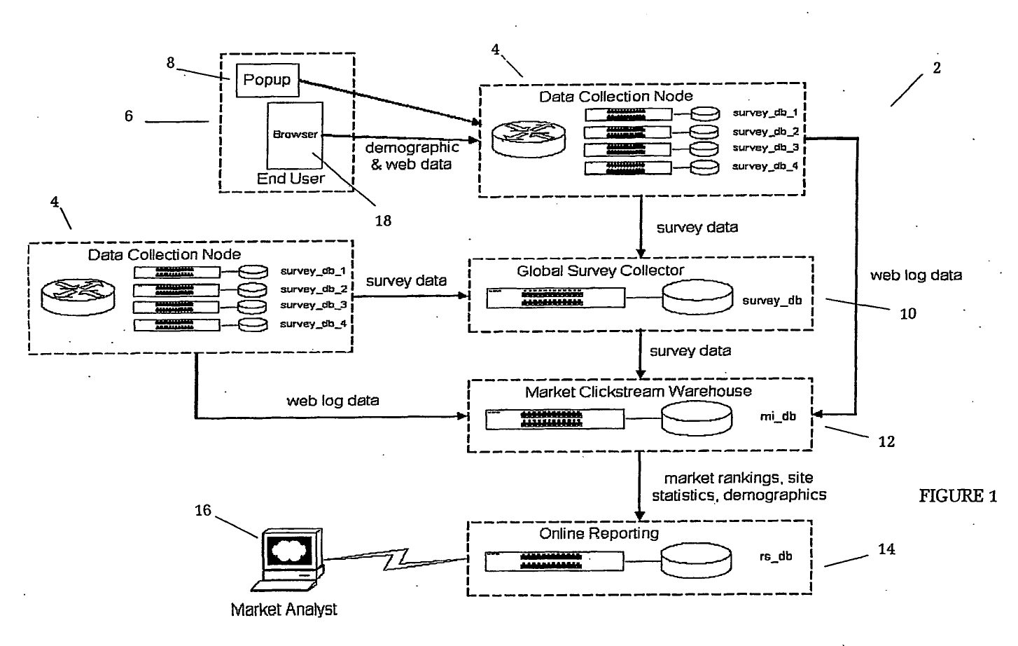

Referring to FIG. 1, there is shown a system 2 that retrieves demographic data and worldwide web data, termed user data, across market segments and provides information in an online reporting database to market analysts. One or more data collection nodes 4 are used to collect the user data, such as page impressions, URL visits, time spent on a particular web page or at a particular web site by an end user 6, and demographic data which is based on surveys, typically provided by a pop-up survey 8. A global survey collector 10, essentially a second electronic storage means or database, is responsible for maintaining a repository of all surveys that have been completed by any end user, regardless of the market segment. A system 2 also includes a market click stream warehouse 12, essentially a first electronic storage means or database, which is responsible for loading web load data or user data specific to a particular market with demographic survey data applicable to the market into a single click stream data format. An online reporting database 14 is a database that is queried by market analysts and contains market ranking data, web site measurement statistics and demographic data applicable to the market analysis. A market analyst uses a processing means 16 linked to the database 14 in order to retrieve the information stored in database 14.

The data collection nodes 2 are composed of a number of sub-modules which include a measurement module, a survey initiator and a survey module. Furthermore, a measurement code is transferred to an end user by the data collection node. The measurement code is placed within the customer web pages and executed by the end user browser 18. A customer or client in this sense is taken to mean an entity that has an agreement with the owner of the system 2 to implement a measurement code on web pages of the client or customer in order to track the behaviour of end users across a market segment. The measurement module is responsible for taking browser based web measurements through the use of measurement code and for initiating surveys through the use of survey initiation code. The survey module is responsible for running the surveys and collecting the survey responses.

Thus, when an end user 6 requests a web page from a customer's web server, the page is returned to the end user 6 with a small portion of a computer program, in the form of a code typically written in JavaScript. The end user browser then executes this code which causes a request to be sent from the end user to the data collection node 4. The data collection node on receiving the request returns the site measurement code to the browser of the end user and optionally a survey initiation code. The end user browser then sends a measurement record to the data collection node 4 which records the measurement data in its logs or files. As mentioned previously, when the data collection node 4 returns the site measurement code in full to the end user browser, the end user may also be sampled for survey initiation and a cookie is dropped in their system. There may be slight variations in the process for some end user platforms, however in all scenarios at the very least a measurement record will be returned to the data collection node 4.

Alternatively, once the user browser 18 executes the small computer program or code embedded in the web page, a measurement record is taken and delivered to the data collection node 4 for further analysis. The measurement record may include the URL of the web page accessed, the referer of the web page, the IP address, the browser type that the user is using, the operating system type that the user is using, the time of day that the measurement record was taken and the identification of the user, which may be a unique identification code or cookie. There are other measurements within that record such as screen resolution and colour palette which are standard properties related to the browser. When the data collection node receives the measurement record it analyses it to determine whether a survey has been presented to the user or otherwise completed by the user. If such a survey has been presented to the user it will be identified by a survey code within the measurement record or possibly within a cookie contained in the measurement record. If it is determined that a survey has not been presented to the user, then the user is sampled and a survey initiation code is sent back to the browser 18 together with further a measurement code compatible with the end user platform. During this process a cookie is dropped onto the browser of the end user. The survey is preferably filled out by the user and sent back to the data collection node to be processed by the survey module and then later stored in the survey database 10.

As mentioned, if as a result of the sample, a survey has not been initiated on the end user, at the time that the full site measurement code is returned to the end user browser, the survey initiation is performed. It is implemented in such a way as to be able to facilitate the market level demographic tracking of each of the end users. The particular sample rate may be controlled on the server side by the operator of the system and the client may have the option to disable surveys via a simple code variable, typically in JavaScript. The client may also specify which survey to launch via a simple JavaScript variable. When an end user or visitor has been presented with a pop-up survey 8, this fact is recorded into the cookie that was dropped on their system during the survey initiation. As this cookie is visible across all sites within a market segment, the survey is prevented from being presented at subsequent times to the end user even on unrelated sites. The survey response is tagged with the visitor's universally unique identification code. In this way, the system operator is able to link web site activity of the end user to the demographic profile of the end user, which was entered and completed in the pop-up survey 8 by the end user.

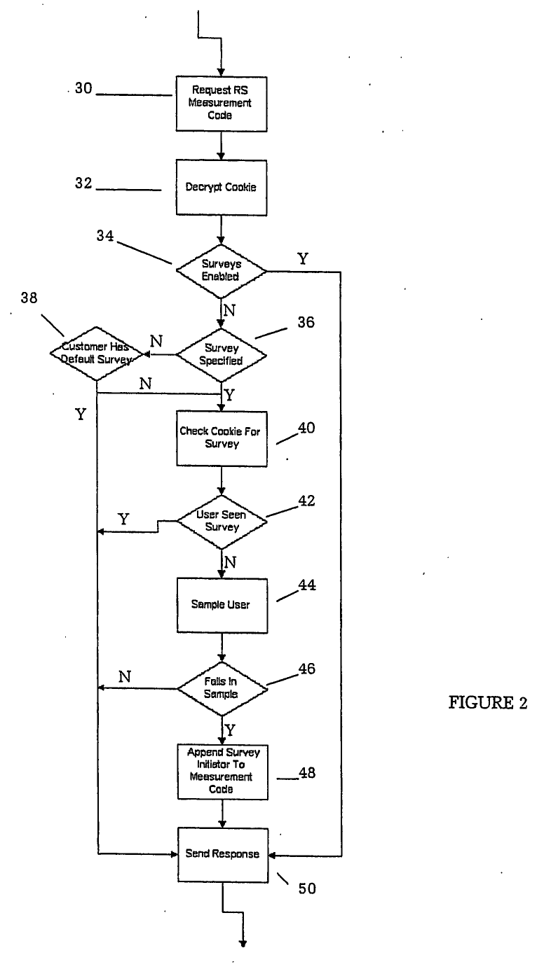

Shown in FIG. 2 is a flow chart depicting the initiation of a survey. At step 30, the request is made from the end user browser to the data collection node 4 in order to download the measurement code after a measurement record is delivered from the browser to node 4. At step 32 the cookie associated with the end user which is in the measurement record is decrypted in order to determine whether a survey has already been presented to that end user. At step 34, if a survey has already been enabled, then a response is sent to the end user at step 50 with the site measurement code. If the survey has not been enabled then the process moves to step 36 where a determination is made as to whether a survey has already been specified for that end user but not enabled. If a survey has been specified then at step 40 a check made by the data collection node as to whether the cookie is present for the specified survey then moves to step 42 to determine whether the end user has seen the survey and if not, then the user is sampled at step 44. If the user has seen the survey then a response is sent at step 50. When the user has been sampled a determination is made at step 46 as to whether the end user falls within the sample and if not, then a response is sent at step 50. If the user falls within the sample then the survey launch code is appended to the measurement code at step 48 and a response is sent at step 50 with that code. Every user who completes a survey becomes part of the sample. Going back to step 36, if a survey has not been specified, then at step 38 a determination is made as to whether the particular customer or client has a default survey and if yes then a response is sent to the end user at step 50. If not, then the system checks for a cookie for the survey at step 40.

A typical example of the questions asked in a pop up survey 8 to the end user, from which one of a number of responses may be supplied, include the following:

1. What type of computer are you using today?

2. Do you use the Internet or email on this computer for work or personal reasons?

3. Where are you currently accessing the Internet?

4. In total, how often do you access the Internet across all locations at home, work and elsewhere? For email? For other purposes?

5. What is your gender and in which year were you born?

6. Which of these best describes your occupation?

7. What is your approximate total and your household income before tax?

8. In what country do you normally reside?

9. What is your nationality?

10. Which ethnic group do you mainly belong to?

As mentioned previously the code used to initiate the survey is a portion of a JavaScript code that is appended to the instrumentation (measurement code) when it is sent from the data collection node 4 to the end user browser 18. Apache Module software performs a sampling of users for survey initiation and the cookie delivered to each user keeps a record of which surveys have been served to each user. Each end user will only be presented with a survey if they are sampled successfully and there is no record of the same survey in their cookie. The instrumentation, or the downloading of the measurement code, includes a parameter to enable or disable the surveys for a particular web page. If surveys are enabled for the instrumented page, but no survey has been enabled for the client, users will not be presented with a survey. Each client can also specify a particular survey to be served using a parameter in the instrumentation. If this particular survey has not been enabled for the client, users who visit the instrumented page will not be presented with a survey. If the client has not specified a survey for the instrumented page, sampled users will be presented with the first survey enabled for that client in the server configuration file.

Thus, the cookie for each end user will have recorded therein a particular survey, identified by a survey code, that the user has completed. The user's unique ID has been tagged with the survey response and is stored in the data collection node. Thus among the participating clients or customers in the market segment which is being monitored, the measurement code embedded in the browser of the end user will enable tracking of the end user as to which web sites, web pages, page impressions that they make in using the world wide web. Therefore, once a survey has been filled out, a link to demographic data about the particular end user may be matched to the visits or hits that the end user makes on the web. Even for those customers or clients who have web sites that are part of the market segment being monitored, they need not have a survey available for the end user to fill out as one has already been completed by the end user.

If surveys are to be run at a market level, that is the same survey is to be launched across more than one client, a survey identification should not be specified in the JavaScript measurement code sent to the end user. This is because the survey initiator uses the survey ID as the key to a look up table for the actual survey configuration. For a market level survey there will be multiple entries for a single survey ID and the system will not know which survey configuration to use.

When an end user completes an online survey, the user identification is recorded with the survey response and is the same as the ID that is recorded in the server web logs. Thus, if the system has previously measured the sampled end user it is possible to retrospectively apply the demographic profile to the historical click stream data in the warehouse 12.

With reference to FIG. 1 again, the demographic data and web data (user data) is sent from the end user browser 18 to the data collection node 4. From there the web log data is then forwarded to the market click stream warehouse 12 and the survey data taken from the pop-up menu 8 is forwarded to the global survey collector or second database 10. The market click stream warehouse 12 then merges these two streams of data together to form a useful report for market analysts which is to be stored in the online reporting database 14.

The survey collector database 10 maintains the demographic profiles of each end user across all the market segments that the system operates within. The database 10 can be queried to obtain market level demographic information. In order to obtain site or publisher level information, it is necessary to combine the demographic data repository with the click stream data warehouse. Thus, the click stream data warehouse 12 combines all of the market level web log data with demographic profiles recorded for the market. Therefore, from this warehouse database, it is possible to obtain:

1. absolute measures of participating site and publisher rankings, in terms of unique visitors, page impressions, page duration, session duration, frequency and a host of other relevant measurements;

2. comparisons of site and publisher demographics based on a continuous survey based panel;

3. duplication across sites or publishers;

4. market reach; and

5. market reach and frequency of visiting any combination of sites or sub-sites (those parts of a site down to page level) for any combination of demographic or psychographic or behavioural variable collected via pop-up surveys.

Many other forms of analysis are possible, however, the important point is that ranking and site measurement is performed at a census level whereas the demographic analysis is based on the end user or visitor profiles derived from the survey responses.

In situations where the JavaScript or measurement code that is returned to the end user by the data collection node 4 is cached by the browser or by intermediate proxys, such as a proxy server, problems may exist with accurate measurement of all page impressions, cookie management and survey management. In order to minimise this, a cache busting technique needs to be implemented for the calls or transmissions back to the data collection nodes. Since proxys and browsers can be configured to cache as much as possible, two techniques will be utilised in order to overcome this. Firstly, a random number in the URL is included so that every call or transmission appears as a new request. Secondly, the HTTP specifications allow for various options to control the caching of pages and these will be set to disallow caching.

The instrumentation or measurement code may be implemented using a V5.0 customer intelligence instrumentation platform. The instrumentation works in conjunction with a new Apache Module and a Perseus Survey software which is designed to replace the existing V4 Customer Intelligence model, whilst also allowing backward compatibility for clients using older versions of the Instrumentation. Implementing the measurement code from the data collection nodes 4 to the end user browsers 18 and returning a measurement record from the browser 18 is achieved using several techniques. The client site instrumentation calls a JavaScript source file Version 4 browsers and above or posts a measurement record by making an image call directly to the CGI for lower version browsers or those where JavaScript is not available. The client's side instrumentation can enable or disable survey delivery and specify particular surveys for the instrumented page. A new Apache Count Module will determine the browser and operating system of each of the end users and then return JavaScript code customised to detect features of that browser type. The new Apache Count Module will also determine whether a survey is available to be served for the client's site and the user is then sampled. Appropriate code to launch the survey will be returned as part of the instrumentation. Lastly, a second call to the servers of the system is made to deliver a measurement record to those servers.

Another import service provided by the V5 measurement module is a “clickthrough gateway”. This is where the gateway built into the module redirects the browser to a particular URI (Uniform Resource Identifier) via a 302 redirect header while at the same time taking a measurement of the browser action. The V5 measurement module provides the capability to do generic 302 redirects. In order to measure a link, the link must be wrapped, for example, example, the target URL is mapped into an SI field and the referer is mapped to the referer field. The ci and cg are combined to form the full customer identification.

Then the URL is accessed, and a measurement is taken and a 302 redirect is performed to the target URL. Bounced measurement can be applied to the e-commerce module as to track links and other affiliate links.

The implementation of the measurement and recording system is as follows. On the client side the V5.0 instrumentation is customised before delivery to the client. The client should copy the instrumentation to the bottom of the measured page, just before the </body>tag. An example of the V5.0 instrumentation is:

<!-- START RedSheriff Measurement V5 -->
<!-- COPYRIGHT 2002 RedSheriff Limited -->
<script language=“JavaScript” type=“text/javascript”><!--

var _rsSI=escape(window.location);
var _rsRP=escape(document.referrer);
var _rsCI=“<account>”;
var _rsCG=“<group>”;
var _rsND=“//<data-node>.imrworldwide.com/cgi-bin/”;
if (parseInt(navigator.appVersion)>=4) {

var _rsRD=(new Date( )).getTime( );
var _rsSE=“0”;
var _rsSV=“”;
_rsCL=‘<scr‘+’ipt language=“JavaScript” type=“text/javascript” src=’”

+_rsND+‘j?ci=’+_rsCI+‘&rd=’+_rsRD+‘&se=’+_rsSE+‘&sv=’+_rsSV+‘”><Vscr’+‘ipt>’;

} else {

_rsCL=‘<img src=’“+_rsND+‘m?ci=’+_rsCI+‘&cg=’+_rsCG+‘&si=’+_rsSI+‘&rp=‘+_rsRP+’”>’;

}
document.write(_rsCL);

//--></script>
<noscript>
<img src=“//<data-node>.imrworldwide.com/cgi-bin/m?ci=<account>&amp;amp;cg=<group>” alt=“”>
</noscript>
<!-- END RedMeasure V5 -->

The instrumentation has been simplified from previous versions which has been achieved in conjunction with the ability to serve custom JavaScript dependent on the end user platform. The meaning attributed to each of the variable names are as follows:

| Variable Name | Description |
|---|---|
| _rsCI | Client account name |
| _rsCG | Content group of the page being measured |
| _rsSE | Surveys enabled/disabled |
| _rsSV | ID of Survey to launch from page |

NB: Variables below should not be altered

| | |
|---|---|
| _rsSI | URL of the page being measured |
| _rsRP | Referrer of the page being measured |
| _rsRD | Date stamp also used to generate random number |
| _rsND | Regional RedSheriff Data Node; eg server-au |

When the Instrumented page loads in a browser window and the JavaScript code executes, the variables are read in or determined dynamically. These variables are fundamental to the correct function of the V5.0 Instrumentation, so it is very important that they are set correctly. The following instructions for customisation below must be undertaken carefully to set the appropriate variables. Any other variables should not be altered.

As the code executes, it determines the end users platform and customises the remaining code execution accordingly. Different platforms are capable of providing varying levels of information about the end user's environment. Therefore by making the behaviour of the code dependant on platform, the amount of information received can be optimised.

With regard to JavaScript enabled browsers, these are handled in two possible ways.

1) Browsers above version 4 use a more advanced version of JavaScript and are therefore treated differently. These browsers download a JavaScript Source file from the data collection node 4. The appropriate JavaScript code is returned for the end users platform. This code is then used to determine certain features of their environment, such as screen resolution and colour depth, and all collected details are posted back to the node 4.

2) All other JavaScript browsers immediately post a record back to the node 4. This record does not contain all the information available to version 4 browsers, however at a minimum the account name, content group, URL and referrer are returned.

Browsers which have JavaScript disabled or do not have JavaScript at all, will immediately post a record back to the node 4, containing at least the account name, content group and URL.

The V5.0 Instrumentation must be customised before delivery to the client. There are variables which can be customised by the client themselves, however they should be advised of the possible consequences should a mistake be made.

The following should be altered by the system owner or operator before delivering instrumentation to the client.

The client must not alter these variables. _rsCI

This should be set to the clients account name. The client should NOT alter this variable themselves.

Eg._rsCI=“redsheriff”;

_rsND

The regional Data Node closest to the client should be selected. The client should NOT alter this variable.

Eg_rsND=“//server-au.imrworldwide.com/cgi-bin/”;

<img . . . >

In the case of non-JavaScript browsers, the variables set above will have will no effect. Therefore the <img>call in the <noscript>section must be edited. The client should only alter the cg=xxxx section according to site structure. Eg. <img src=“//server-au.imrworldwide.com/cgi-in/m?ci=redsheriff&amp;cg=news” alt=″″>

NOTE: Set <group>to “0” in the default code to be sent to the client.

The following may be altered before delivering instrumentation to the client, however the client is able to alter these variables after training in their meaning.

_rsCG

For clients utilising the system owner technology, the content group can be set for a page, to allow more simplified reporting. The client may alter this variable according to site structure, however it is advisable that they work closely with the system owner to setup appropriate reports.

Eg._rsCG=“news”;

NOTE: Set this to “0” in the default code to be sent to the client.

_rsSE

If a client wishes to deliver surveys from the page containing the instrumentation, they must enable surveys on that page. If a survey has not been configured at the backend for the clients account, no survey will be launched. Therefore it is possible for a client to enable surveys in the instrumentation but not have a survey launch until it has been configured at the backend.

Eg._rsSE=“1”

Alternatively, if a client wishes to ensure that no survey is ever launched from a particular page, they can easily disable surveys in the Instrumentation.

Eg._rsSE=“0”

_rsSV

It is possible for a client to run multiple surveys on their site at one time or for a regional demographic survey to be running in conjunction with a client survey. To allow the client to specify which survey they want launched from any particular page, they can set the survey ID variable.

Eg._rsSV=“re3005”

Implementation

After the variables have been set appropriately, it is advised that the client place the code just before the closing </body>tag, within the HTML of the desired page(s). The code has been tested to work when placed in this area of a page. The client may place the code elsewhere, however they should be advised that the system operator cannot guarantee the full functionality of the code in all platforms, if placed in another area.

The Apache Measurement Module implemented as an Apache 1.3 Module, which conforms to and uses the APIs of the Apache 1.3 source tree, has several main functions. The module returns the measurement code, tailored for the particular browser type, performs actual browser measurements, initiates surveys, undertakes user tracking via a globally unique cookie identification, redirects support and measurement, undertakes ad measurements, streaming measurements and attracts issued cookies. Data is written from the Apache Measurement Module into a system V message queue depending on the type of data being written.

The particular cookies used in this embodiment has a maximum size of 4096 bytes. The following table lists the currently defined tables to be stored in the cookie:

| Name | Type | Description |
|---|---|---|
| ID | String | The unique visitor ID as assigned by mod-uniq |
| | | or migrated from the IMRID cookie value |
| ASSIGN_TI | Integer | The time (epoch) that the cookie was assigned |
| COUNT_PI | Integer | The count of pages that the browser has visited, |
| | | it is incremented on every page view |
| LAST_TI | Integer | The time (epoch) that the browser visited a site |
| | | measured by RedSheriff |
| SESS_LEN | Integer | The length of the current session |
| SV_LIST | List | The list of surveys that the user has been |
| | | presented with |

To guarantee the integrity of the issued cookies, when a new cookie is created the cookie payload is serialised, a sixteen bit CRC over the serialised cookie payload is calculated, the cookie payload and the CRC are encrypted and the encrypted cookie payload is then base-64 encoded. When a request is received with a cookie, the reverse procedure is followed. If the cookie CRC check fails, an error is logged and a brand new cookie is issued. When a new cookie is issued by the system, a record is written to a special message queue. The cookie ID is stored, together with the time the cookie was issued and the site the cookie was issued against and other identifying information about the browser to which the cookie was issued. In this way, a trace can be made of how many cookies have been issued over a certain period of time.

In order to detect browsers with cookies that are disabled, an assignment is applied to the cookie on the initial request for the server side JavaScript file. When the actual measurement request is taken, then it is asserted that if there is no cookie on the incoming request that the browser then has cookies disabled.

As mentioned previously in a normal scenario the server JavaScript file may be cached by a browser or by an intermediate proxy. This can cause problems with cookie management and survey management. In such an instance, cache busting techniques need to be implemented for the JavaScript file as well as to append a random number to the URL and set a no-cache flag and expire the headers in the module itself.

As mentioned previously the survey initiation code is returned to the end user's browser at the same time that the measurement code is delivered where it is appended to the measurement code. Survey initiation is controlled by the survey configuration file and Apache directives related to survey template file locations. The logic to launch a survey is as follows:

1. If the survey enabled flag (j.se) is not set then no survey will be launched. This flag must be specifically enabled by the client to enable surveys.

2. If the survey id flag (j.sv) parameter is passed in then the specific survey will be launched.

3. If the j.sv flag is not set then the default survey must be found for the customer (based on the j.ci argument) and launched.

Once the survey for launch has been selected:

1. Check that the survey is still active by comparing the request time with the start and end date of the surveys,

2. Check that the survey is registered with that client,

3. Sample the user via a random generation routine.

If all three tests pass, then the survey code is appended to the Measurement JavaScript code and passed back to the user.

With regard to the survey configuration setup, the location of the survey configuration file is controlled by the RSSurveyConfiguration Apache directive. The configuration file is a tab separated file and an example is given below:

## tab separated text file
##
## client_id survey_id survey_type active sample_rate start_date end_date
##
## $Id: surveys.cfg,v 1.1 2002/08/19 08:31:55 jgriffin Exp $
##
## start_date and end_date are RFC 822 format and only accept GMT
## active is boolean 1 | 0
## survey_type can be free form, however “custom” is reserved
##

| | | | | | | |
|---|---|---|---|---|---|---|
| redsheriff | RS001 | a | 1 | 10 | Sun, 06 Nov 2001 12:00:00 GMT | Mon, 07 Dec 2002 12:00:00 GMT |
| redsheriff | RS002 | a | 1 | 10 | Sun, 06 Nov 2001 12:00:00 GMT | Mon, 07 Dec 2002 12:00:00 GMT |
| redsheriff | RS003 | a | | 1000000 | Sun, 06 Nov 2001 12:00:00 GMT | Mon, 07 Dec 2002 12:00:00 GMT |

| Field | |
|---|---|
| Position | Description |
| 0 | The customer identifier. The customer can be associated with |
| | many surveys, however, the last survey in the configuration |
| | is considered to be the customer's default survey. |
| 1 | The survey identifier, a free-form text field. |
| 2 | The survey type. It is useful to categorise surveys into types |
| | (for example, a cross-domain survey). If the type of the |
| | survey is “custom”, then this survey is considered to |
| | be custom and a different survey template will be used |
| | (see below). |
| 3 | The active flag. 1 indicates that the survey is active. |
| 4 | The sample rate, as parts per million. |
| 5 | The start date for the survey, in RFC 822 format. |
| 6 | The end date of the survey, in RFC 822 format. |

The fields are explained in the table below:

With regard to survey templates, the location of the survey template directory is controlled by the RSSurveyBaseDir Apache directive.

Within this directory there are two sub-directories:

1. std—the location of standard surveys

2. custom—the location of the custom surveys

When a standard survey is being launched, the system will look into the RSSuveyBaseDir/std directory for a file $type. When a custom survey is being launched, the system will look into the RSSurveyBaseDir/custom directory for a file $survey_id i.e. the survey template is determined by the survey id rather than the survey type.

The survey templates implement a simple substitution mechanism. The following table describes the variables that may be substituted:

| Variable Name | Description |
|---|---|
| $ID$ | The visitor unique identifier |
| $SVID$ | The survey ID |

The Apache module can be thought of conceptually as an application program interface or API where methods are represented by URLs and arguments to these methods are URL arguments. The number of APIs perform certain functions such as the j API which returns the measurement code or measurement JavaScript tailored for the particular browser, returns survey initiation code and issues tracking cookies. Another type of API is the m API which undertakes browser measurements and issues cookies. A bounce measurement API b affiliates link tracking, coordinates landing pages and optimises search engines. Lastly there is the add measurement API a which measures the add impressions and add clicks, issues cookies for tracking visitors or users and redirects to a target URL if appropriate.

The configuration for the Module is performed by standard Apache module APIs. The advantage of this approach over a stand-alone configuration is that it is easy to have per virtual server configurations. The Apache core will perform all of the hard tasks of ensuring that the appropriate configuration is available at the correct time. Various directives are available.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A system for measuring and recording user data in a communications network and associating the user data with demographic data of the user, the user being able to access a user computer processing means having browser means, the system comprising:
data processing means for receiving from the browser means a measurement record after the user accesses a part of the network having a portion of measurement code embedded therein;
the data processing means determining from the received measurement record whether a survey identified by a survey identifier has been presented to the user;
whereupon if the survey identifier is not detected, the data processing means forwards survey initiation code together with compatible measurement code to the user in order to complete a survey including the demographic data of the user;
the system further comprising:
first electronic storage means for receiving survey data of the user and the measurement record of the user, each being linked to the another and identified through a user identification code;
whereupon an interested party has access to information based on the measurement record and survey data of the user for the purpose of ascertaining information about the user in a market segment.

2. A system according to claim 1, wherein prior to the data processing means receiving the measurement record from the browser means, the browser means executes the portion of measurement code embedded in the accessed part of the network and sends a request to the data processing means.

3. A system according to claim 2, wherein the data processing means delivers the compatible measurement code to the browser means after receipt of the request.

4. A system according to claim 1, and further comprising:
second electronic storage means for storing the survey data, including demographic data, of the user.

5. A system according to claim 4, wherein the second electronic storage means comprises survey collection means.

6. A system according to either one of claims 4, wherein the second electronic storage means is linked to the data processing means, in the form of a data collection node, for receiving the survey data of the user.

7. A system according to claim 1, wherein the first electronic storage means is linked to the second electronic storage means for receiving the survey data of the user and is also linked to the data processing means for receiving the measurement record.

8. A system according to claim 7, wherein the first electronic storage means comprises a market clickstream database.

9. A system according to claim 1, wherein the first electronic storage means processes and assembles said information for the interested party based on the survey data and measurement record of the user, and forwards the information to an online reporting database.

10. A system according to claim 9, wherein the online reporting database is then accessed by the interested party to access the information.

11. A system according to claim 10, wherein the information is retrieved by the interested party by compiling a set of queries.

12. A system according to claim 1, wherein the measurement record includes the user identification code.

13. A system according to claim 1, wherein the measurement record includes a cookie including the user identification code.

14. A system according to claim 13, wherein the cookie includes the survey identifier, and upon detection of the survey identifier, the survey identified by the survey identifier is not delivered to the user browser means.

15. A system according to either one of claims 13, wherein, where survey initiation code is forwarded to the user browser means, the survey initiation code is appended to the measurement code forwarded by the data processing means and the cookie applied to the browser means.

16. A system according to claim 15, wherein once a survey is completed by the user, the survey is then appended to or tagged with the user cookie and returned to the data processing means for storage in the second electronic storage means.

17. A method of measuring and recording user data in a communications network and associating the user data with demographic data of the user, the user being able to access a user computer processing means having browser means, the method comprising the steps of:
the user accessing a part of the network having a portion of measurement code embedded therein;
forwarding a measurement record from the browser means to a data processing means;
determining from the received measurement record whether a survey identified by a survey identifier has been presented to the user;
whereupon if the survey identifier is not detected, survey initiation code is forwarded with compatible measurement code to the user in order to complete a survey including the demographic data of the user; and
forwarding the completed survey response data and measurement record to a first electronic storage means, each linked by a common user identification code;
such that an interested party has access to information based on the measurement record and survey data of the user for the purpose of ascertaining information about the user in a market segment.

18. A method according to claim 17, and further including the step of:
upon detection of a survey identifier, the survey data is stored in the first electronic storage means available for retrieval or processing.

19. A method according to claim 18, wherein the stored survey data is identified by the common user identification code to enable the survey response data to be used in conjunction with the measurement record.

20. A system for measuring and recording user data in a communications network and associating the user data with demographic data of the user, the user being able to access a user computer processing means having browser means, the system comprising:
data processing means for receiving from the browser means a measurement record after the user accesses a part of the network having a portion of measurement code embedded therein;
wherein the data processing means determines from the received measurement record if the survey identified by a survey code has been presented to the user and completed by the user;
wherein, where the survey has been completed by the user and survey data stored in a first electronic storage means, the measurement record, containing a portion of the user data, is forwarded to the first electronic storage means;
the measurement record and the survey data, including demographic data of the user, being identified by a user identification code;
wherein an interested party has access to information based on the measurement record and survey data of the user for the purpose of ascertaining information about the user in a market segment.

21. A system according to claim 20, wherein compatible measurement code is sent from the data processing means to the browser means in order to measure and record user data of the user as the user accesses various portions of the network.

22. A system according to claim 21, wherein the network is the Internet.

23. A system for measuring and recording user data in a communications network and associating the user data with demographic data of the user, the user being able to access a user computer processing means having browser means, the system comprising:
data processing means for receiving from the browser means a measurement record after the user accesses a part of the network having a portion of measurement code embedded therein, the measurement record forming part of the user data;
wherein a user identification code is applied to the browser means to provide the user data in the network in a market segment;
first electronic storage means for storing survey data containing demographic data of the user; said survey data linked to the user data by the user identification code;
wherein an interested party obtains information about the user based on demographic data of the user in combination with the user data across the market segment.

24. A system according to either one of claims 5, wherein the second electronic storage means is linked to the data processing means, in the form of a data collection node, for receiving the survey data of the user.

25. A system according to either one of claims 14, wherein, where survey initiation code is forwarded to the user browser means, the survey initiation code is appended to the measurement code forwarded by the data processing means and the cookie applied to the browser means.
